(19) United States
(12) Patent Application Publication
(10) Pub. No.: US 2015/0258854 A1
(43) Pub. Date: Sep. 17, 2015

(54) TIRE CORD FABRIC AND PRODUCTION METHOD THEREOF

(71) Applicant: KORDSA GLOBAL ENDUSTRIYEL IPLIK VE KORD BEZI SANAYI VE TICARET ANONIM SIRKETI, Izmit (TR)

(72) Inventors: Sadettin Fidan, Garbsen (DE); Kürsat Aksoy, Izmit (TR)

(73) Assignee: KORDSA GLOBAL ENDUSTRIYEL IPLIK VE KORD BEZI SANAYI VE TICARET ANONIM SIRKETI, Izmit (TR)

(21) Appl. No.: 14/424,443

(22) PCT Filed: Sep. 17, 2013
(86) PCT No.: PCT/IB2013/058607

§ 371 Date: Feb. 27, 2015

(30) Foreign Application Priority Data
Oct. 18, 2012 (TR) 2012/12031

(51) Int. Cl. B60C 9/00; D02G 1/00; D02G 1/02

(52) U.S. Cl. CPC B60C 9/0042; D02G 1/02; D02G 1/004; B60C 2009/0092

(57) ABSTRACT

The present invention relates to a tire cord fabric (1) which is used as reinforcement in vehicle tires (L) and wherein the cord (2) twists within its structure vary depending on the area to which they will correspond, and a production method thereof. The processed cords used as warp yarns in the inventive tire cord fabric (1) are produced by twisting the cord with initial twist (K) again and fixing from the twist points (4) with thermal, mechanical and/or chemical methods so that the twist levels of the twist zones (3) having different twists do not change.

### Field of the Invention

The present invention relates to a tire cord fabric which is used as reinforcement in vehicle tires and wherein the cord twists within its structure vary depending on the area to which they will correspond, and a production method thereof.

### BACKGROUND OF THE INVENTION

The physical properties of the cords used in vehicle tires are strongly dependent on twist levels.

For a polymeric material used as cord material, the results of the increase in cord twist are as follows:
breaking strength and modulus decrease,
elongation at break increases,
bending and fatigue resistance under axial compression improves.

As it can be understood from the results mentioned above, the physical features of the cords having strong effect on the tire performance can be controlled by changing the twist level or the cord helix angle (for a material such as rayon, polyester, polyamide yarns).

According to the tire and tire cord technologies in the state of the art, tire reinforcement cords are the elements twisted homogenously (constant twist along the cord). On the other hand, in carcass of the passenger vehicle tire;
shoulder zone is a flexible zone and requires high flex fatigue resistance,
sidewall zone of the tire is relatively stiff zone with less deformation,
turn up zone requires relatively higher twist levels and it is the lateral and bending compression zone,
underbelt zone has low lateral deformations and low twist is enough in cords which are used.

Japanese Patent application no JP2009029310, an application known in the state of the art, discloses a pneumatic radial tire having a reinforcement layer supported with steel cords. The reinforcement layer is comprised of a great number of steel cords and coating rubber which coats the said steel cords. The S and Z twisted steel cords present in a strip together have similar cord diameter and are made of similar material, but they have different twisting direction.

Japanese Patent document no JP2008044550, another application known in the state of the art, discloses a pneumatic radial tire which is reinforced with a carcass layer having different areas corresponding to different parts of the tire. Carcass has a belt layer comprising one or more than one processed material. At least one part of the said processed material is manufactured from rubber coated fabric formed from organic fiber cords or carbon fiber cords, and its other part is manufactured from rubber coated fabric formed from steel cords. The cords within the processed material are parallel to each other and their twisting directions are different in each yam.

A similar application is also mentioned in Japanese Patent document no JP2008044396.

### SUMMARY OF THE INVENTION

The objective of the present invention is to provide a tire cord fabric which is used as carcass reinforcement and has different twist levels depending on the different parts of the tire, and a production method thereof.

Another objective of the present invention is to provide a tire cord fabric that provides a good tire performance with variable twist which is the most important parameter controlling the fatigue resistance of the cord since the carcass cord in a pneumatic radial tire is subjected to different stresses and fatigue in different parts of the tire, and a production method thereof.

### BRIEF DESCRIPTION OF THE DRAWINGS

“A tire cord fabric and a production method thereof” developed to fulfill the objectives of the present invention is illustrated in the accompanying figures, in which:

FIG. 1 is the cross-section view of the tire cord fabric and the tire in which it is located as carcass.

FIG. 2 is the view of the cord having the initial twist and the cord which is twisted again for being used in the inventive tire cord fabric.

FIG. 3 is the view of an embodiment of the cord having the initial twist and the cord which is twisted again for being used in the inventive tire cord fabric.

FIG. 4 is the view of another embodiment of the cord having the initial twist and the cord which is twisted again for being used in the inventive tire cord fabric.

FIG. 5 is the view of a further embodiment of the cord having the initial twist and the cord which is twisted again for being used in the inventive tire cord fabric.

FIG. 6 is the view of a further embodiment of the cord having the initial twist and the cord which is twisted again for being used in the inventive tire cord fabric.

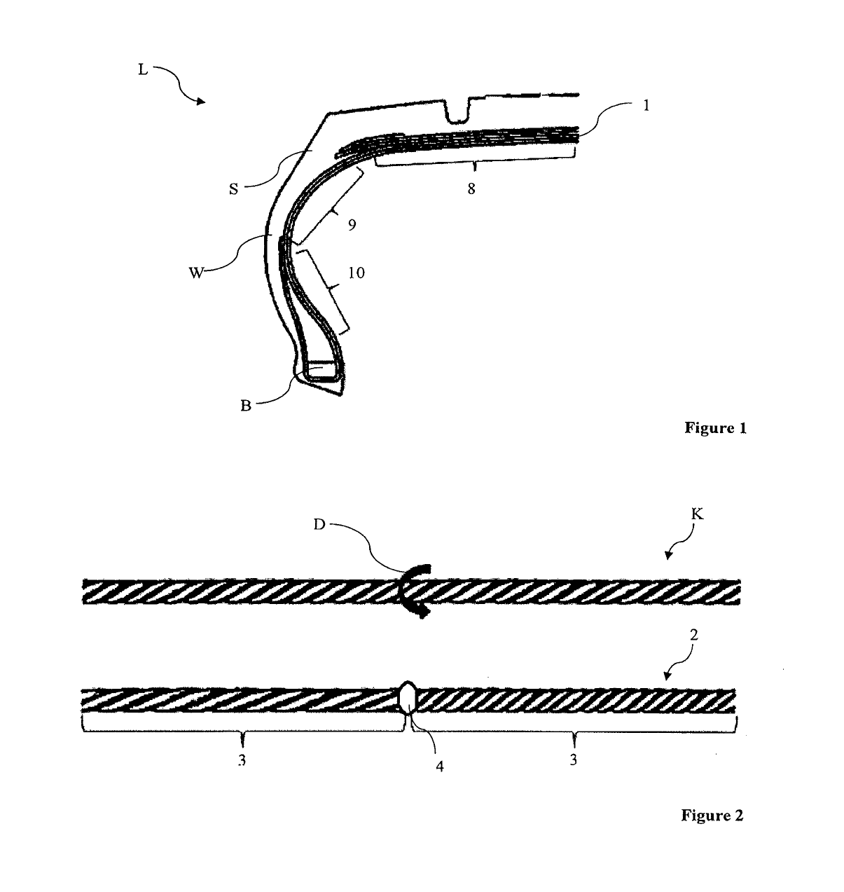

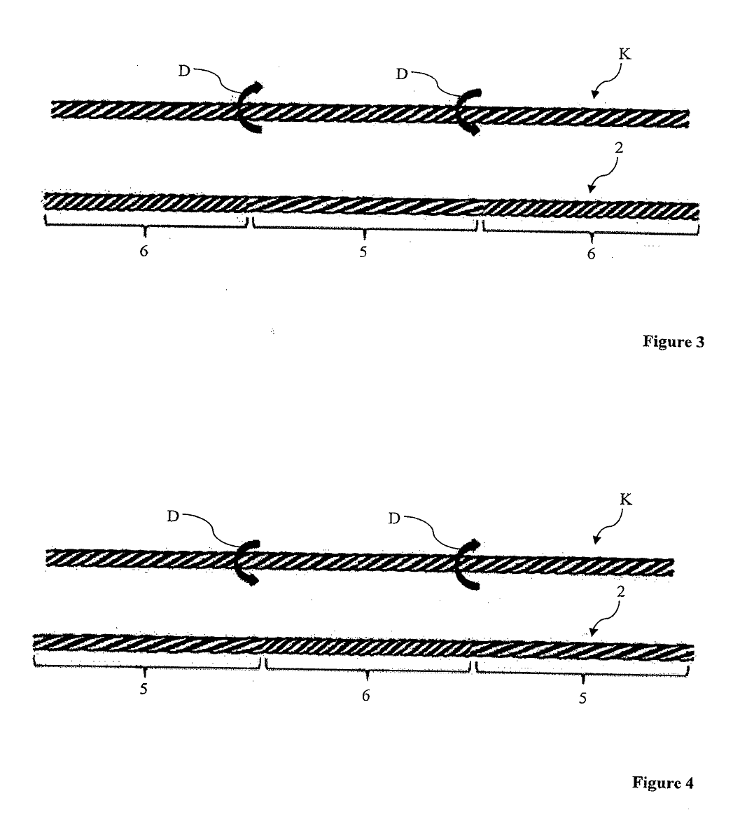

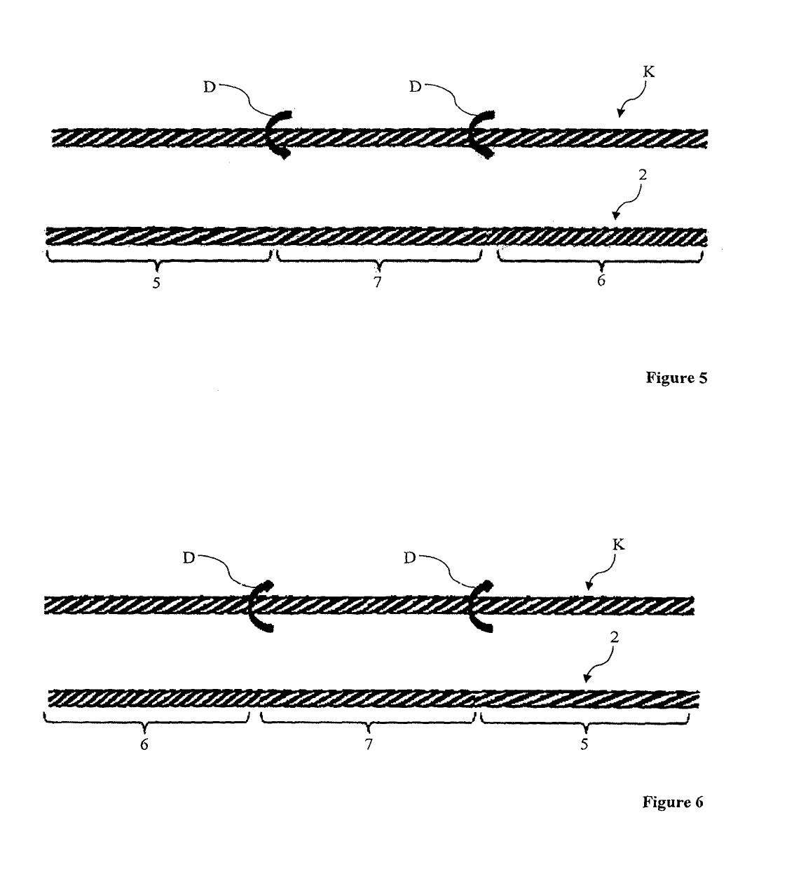

The components given in the figures are numbered and the numbers refer to the following:

11. Tire cord fabric

12. Processed cord

13. Twist reduction-increase zones

14. Twist point

15. Low twist zone

16. High twist zone

17. Initial twist zone

18. Underbelt zone

19. Carcass zone

20. Rigid zone
L. Tire
S. Shoulder zone
W. Sidewall
B. Bead
K. Cord with initial twist
D. Twist direction

### DETAIL DESCRIPTION OF THE INVENTION

The inventive tire cord fabric (1) comprises
a processed cord (2) of which the base structure is constituted by a plurality of warp yarns, is formed by twisting-a cord with initial twist (K) from determined points,
at least two increase-reduction zones (3) on the processed cord (2), which have different twists according to the required condition and the location to which they will correspond on the tire (L),
at least one twist point (4) being the zone wherein the processed cord (2) is twisted again in a determined twist direction (D) depending on the necessary condition, and showing the transition point between the twist reduction-increase zones (3) which have different twisting.

In one embodiment of the invention, at least one twist reduction-increase zone (3) is a low twist zone (5) which is formed as a result of the cord with initial twist (K) being twisted in opposite direction (D) of twist direction from the twist point (4).

In one embodiment of the invention, at least one twist reduction-increase zone (3) is a high twist zone (6) which is formed as a result of the cord with initial twist (K) being twisted in the same direction (D) with twist direction from the twist point (4).

In one embodiment of the invention, at least one twist reduction-increase (3), which is the zone of the cord with initial twist (K) wanted to be kept in the middle twist being different from the low and high twist zones (5, 6), is an initial twist zone (7) which is separated from the said zones (5, 6) by a twist point (4) so that it is not affected by the twists in the said zones (5, 6).

In the preferred embodiment of the invention, the underbelt zone (8) forming the part of the tire cord fabric (1) corresponding to the part of the tire (L) contacting the ground has a low twist zone (5) wherein less fatigue resistance is sufficient compared to the cord with initial twist (K).

In the preferred embodiment of the invention, the carcass zone (9) forming the part of the tire cord fabric (1) corresponding to the shoulder zone (S) of the tire (L) has a high twist zone (6) which has higher fatigue resistance compared to the cord with initial twist (K).

In the preferred embodiment of the invention, the rigid zone (8), forming the part of the tire cord fabric (1) corresponding to the part of the tire (L) between the tire sidewall (W) and the bead (B), has a low twist zone (5) since it is subjected to less fatigue compared to the cord with initial twist (K).

By means of the inventive tire cord fabric (1), a reinforcement element, which can be adjusted to different twist levels according to the requirements of different zones (carcass turn up zone, tire bead zone, tire sidewall zone, shoulder zone and underbelt zone) of the tire (L), can be developed.

The tire cord fabric (1) used as reinforcement in the radial pneumatic vehicle tire (L) has different twist levels depending on the different positions of the tire. The twist difference between the low and high twist zones (5, 6) is between 15-60%. For example, in a 1440x2dtex (linear density) PET radial carcass reinforcement: the shoulder twist is 350 tpm whereas the sidewall is 290 tpm (turns per meter). The maximum twist zone is the shoulder zone requiring high flexibility. In the cord reinforcement corresponding to sidewall and the underbelt zones, the twist level is 15% less than the shoulder zone.

The inventive tire cord fabric production method comprises the steps of
determining the zones to which the cord with initial twist (K) will correspond on the vehicle tire (L),
determining the location and twist levels of twist reduction-increase zones (3) according to the fatigue resistance requirements of the said determined zones,
determining the twist points (4) between the different twist reduction-increase zones (3),
forming different reduction-increase zones (3) by twisting the cord with initial twist (K) again from the twist points (4) according to the fatigue resistance,
fixing the twist points (4) with thermal, mechanic and chemical methods in order that the twist levels of twist reduction-increase zones (3) having different twists do not change after twisting again,
acquiring processed cord (2) by fixing the twist points (4),
acquiring tire cord fabric (1) which is the final product by using processed cords (2).

In producing the inventive tire cord fabric (1), preparing different twist decrease-increase zones (3) is performed right before weaving the tire cord fabric or during weaving. The twist points (4) which are the transition points between the different twist reduction-increase zones (3) are fixed with thermal, mechanical and/or chemical methods. By means of the fixing process, twist transfer from the high twist zone (6) to the low twist zone (5) and/or to the initial twist zone (7) along the cord is prevented. Thus, the stability in the twist reduction-increase zones (3) with different twist is protected. By means of the thermal processing, the torques of the cords (2) are reduced.

Within the framework of these basic concepts, it is possible to develop a wide variety of embodiments of the inventive tire cord fabric (1) and a production method thereof. The invention cannot be limited to the examples described herein and it is essentially as defined in the claims.

1. A tire cord fabric which enables to develop an adjustable reinforcement member having different twist levels according to fatigue resistance requirements in different zones (turn up zone, bead zone, sidewall zone, shoulder zone and underbelt zone) of carcass in vehicle tire, comprising:
a processed cord, of which the base structure is constituted by a plurality of warp yarns, is formed by twisting a cord with initial twist from determined points;
at least two increase-reduction zones on the processed cord, which have different twists according to a required condition and the location to which they will correspond on the tire;
at least one twist point between the zones wherein the processed cord is twisted again in a determined twist direction depending on a necessary condition, and showing the transition point between the twist reduction-increase zones which have different twisting.

2. The tire cord fabric according to claim 1, wherein at least one twist reduction-increase zone is a low twist zone formed by twisting the cord with initial twist again from the twisting point in opposite direction of the twist direction.

3. The tire cord fabric according to claim 1, wherein at least one twist reduction-increase zone is a high twist zone formed by twisting the cord with initial twist again from the twisting point in same direction with the twist direction.

4. The tire cord fabric according to claim 1, wherein at least one twist reduction-increase, which is the zone of the cord with initial twist wanted to be kept in the middle twist being different from the low and high twist zones, is an initial twist zone that is separated from the said zones by a twist point so that it is not affected by the twists in the said zones.

5. The tire cord fabric according to claim 2, wherein the underbelt zone which forms the part of the vehicle tire corresponding to the part contacting the ground has a low twist zone having a lower fatigue resistance compared to the cord with the initial twist.

6. The tire cord fabric according to claim 3, wherein the carcass zone which forms the part of the vehicle tire corresponding to the shoulder zone has a high twist zone having a higher fatigue resistance compared to the cord with the initial twist.

7. The tire cord fabric according to claim 2, wherein a rigid zone which forms the part of the vehicle tire corresponding to the part between the sidewall and the bead has a low twist zone having a lower fatigue resistance compared to the cord with initial twist.

8. The tire cord fabric according to claim 3, wherein the twist level of the high twist zone is 15 to 60% higher than the low twist zone.

9. A tire cord fabric production method, comprising:
determining a plurality of zones to which a cord with initial twist will correspond on a vehicle tire;
determining the location and twist levels of twist reduction-increase zones according to fatigue resistance requirements of the said determined zones;
determining a plurality of twist points between the different twist reduction-increase zones; forming different reduction-increase zones by twisting the cord with initial twist again from the twist points according to the fatigue resistance;
fixing the twist points with thermal, mechanical and chemical methods in order that the twist levels of twist reduction-increase zones having different twists do not change after twisting again;
acquiring a processed cord by fixing the twist points;
acquiring a tire cord fabric which is the final product by using processed cords.

10. The tire cord fabric production method according to claim 9, wherein thermal process is applied to the twist points since it reduces the residual torques of the processed cords.
